(19) United States
(12) Patent Application Publication
(10) Pub. No.: US 2025/0158839 A1
(43) Pub. Date: May 15, 2025

(54) DATA EXCHANGE ATTESTATION METHOD

(71) Applicant: nchain Licensing AG, Zug (CH)

(72) Inventors: Alec BURNS, London (GB); Craig Steven WRIGHT, London (GB)

(21) Appl. No.: 18/839,921

(22) PCT Filed: Jan. 23, 2023
(86) PCT No.: PCT/EP2023/051527

§ 371 Date: Aug. 20, 2024

(30) Foreign Application Priority Data
Feb. 22, 2022 (GB) 2202348.5

(51) Int. Cl. H04L 9/00

(52) U.S. Cl. CPC H04L 9/50

(57) ABSTRACT

A computer-implemented method of attesting to a sequence of data exchanges between a group, wherein the group comprises a receiving party and one or more sending parties, and wherein the method is performed by the receiving party and comprises: receiving a sequence of two or more respective sets of data items, each respective set being sent by a respective sending party; and for each respective set of data items in the sequence: generating a respective attestation transaction, wherein the respective attestation transaction comprises a respective output locked to a respective Merkle root of a respective Merkle tree, wherein the respective Merkle tree is based on the respective set of data items and each previous respective set of data items in the sequence; and sending the respective attestation transaction to at least the respective sending party that sent the respective set.

### CROSS REFERENCE TO RELATED APPLICATIONS

This application is the U.S. National Stage of International Application No. PCT/EP2023/051527 filed on Jan. 23, 2023, which claims the benefit of United Kingdom Patent Application No. 2202348.5, filed on Feb. 22, 2022, the contents of which are incorporated herein by reference in their entireties.

### TECHNICAL FIELD

The present disclosure relates to methods of attesting to a sequence of data exchanges, and to a method of verifying a data item was exchanged between a group.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below.

Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

Data transfer and storage using the blockchain allows for an immutable reference. However only the data that is stored on chain can be guaranteed. The integrity of data that is communicated off-chain and used to derive on-chain data cannot be certain. A “payment channel” allows users to commit an amount of funds to a channel and then redistribute the committed funds between the involved parties off-chain at a higher frequency and lower cost than would be possible for on-chain transactions. A payment channel can also be used to transfer data in the same manner and with the same benefits. However, as these exchanges are performed off-chain their immutability can no longer be guaranteed. It would therefore be desirable to be able to attest to off-chain data exchanges. That is, it would be desirable to be able to attest to the data that has been sent and the order in which the data was sent.

According to one aspect disclosed herein, there is provided a computer-implemented method of attesting to a sequence of data exchanges between a group, wherein the group comprises a receiving party and one or more sending parties, and wherein the method is performed by the receiving party and comprises: receiving a sequence of two or more respective sets of data items, each respective set being sent by a respective sending party; and for each respective set of data items in the sequence: generating a respective attestation transaction, wherein the respective attestation transaction comprises a respective output locked to a respective Merkle root of a respective Merkle tree, wherein the respective Merkle tree is based on the respective set of data items and each previous respective set of data items in the sequence; and sending the respective attestation transaction to at least the respective sending party that sent the respective set.

According to one aspect disclosed herein, there is provided a computer-implemented method of attesting to a sequence of data exchanges between a group, wherein the group comprises a receiving party and one or more sending parties, and wherein the method is performed by a first one of the sending parties and comprises: sending a respective set of data items to the receiving party, wherein the respective set of data items is a final respective set of a sequence of two or more respective sets of data items; receiving a respective attestation transaction, wherein the respective attestation transaction comprises a respective output locked to a respective Merkle root of a respective Merkle tree, wherein the respective Merkle tree is based on the respective set of data items and each previous respective set of data items in the sequence; sending the respective attestation transaction to one or more nodes of the blockchain network, the receiving party, at least one of the one or more sending parties, such that the respective attestation transaction is recorded on the blockchain; generating a final transaction, wherein the final transaction comprises an input that references the respective output of the respective attestation transaction and comprises the respective Merkle root; and sending the final transaction to at least one of: one or more nodes of the blockchain network, the receiving party, at least one of the one or more sending parties.

A sending party is a party that sends data to a receiving party. The receiving party receives a sequence of data sets. Each data set may contain a single data item, or multiple data items. The data is sent from the sending party to the receiving party off-chain, i.e. without the use of the blockchain. The receiving party creates a first Merkle tree using the first data set. That is, each data item in the first data set forms a respective leaf of the first Merkle tree. That is, a data item is hashed to form a leaf node of the Merkle tree. Depending on the number of data items, the first Merkle tree may contain leaf nodes that are not based on a data item. The receiving party then creates a first attestation transaction that includes an output locked to a Merkle root of the first Merkle tree. The Merkle root encodes, and therefore attests to, the data item(s) in first data set and the order of the data item(s). In order for the output to be unlocked, a sending party is required to provide the Merkle root in an input of a final transaction. The sending party is therefore required to generate the same first Merkle tree as the receiving party. Thus both parties must agree upon, and therefore attest to, the same data items and the same order of data items. That is, this protocol forces both the receiving party and the sending party to attest to the same exchange of data.

When the receiving party receives a second data set (from the same sending party or a different party), the receiving party updates the first Merkle tree by using each data item of the second data set. That is, each data item of the second set is hashed to form a respective leaf of the second Merkle tree. The receiving party generates a second attestation transaction that includes an output locked to a Merkle root of the second Merkle tree. The Merkle root encodes, and therefore attests to, the data item(s) in the first and second data sets, and the order of the data item(s). That is, the Merkle root attests to a sequence of data exchanges.

The receiving party may receive any number of data sets. Each time the receiving party receives a new data set, the receiving party updates the previous Merkle tree and generates a new attestation transaction with an output locked to the Merkle root of the latest Merkle tree.

The sending party attests to the sequence of data exchanges by submitting a transaction to the blockchain which includes a Merkle root of a Merkle tree based on the data items in the sequence of data exchange. In this way, both sending and receiving parties attest to knowing all of the data sent as part of the exchange.

The Merkle tree evolves as more data sets are received. This evolving Merkle tree may be used to sequence, lock and unlock transactions within a payment channel. This mechanism enforces a dependency between data exchanges, ensuring that a sending party must solve the relevant Merkle root to unlock any attestation transactions. In doing so, data authenticity can be guaranteed once the payment channel is closed on-chain and the Merkle root revealed.

According to one aspect disclosed herein, there is provided a computer-implemented method of verifying a data item was exchanged between a group, wherein the method is performed by a verifier and comprises: obtaining a final transaction from a blockchain, wherein the final transaction references an output of an attestation transaction and comprises a Merkle root of a Merkle tree, wherein the attestation transaction comprises an output locked to the Merkle, wherein the Merkle tree is based on each set of data items belonging to a sequence of two or more respective sets of data items; obtaining a set of inner hashes of the Merkle tree; and performing a Merkle proof for a candidate data item using the set of inner hashes and the Merkle root to verify that the candidate data item belongs to one of the respective sets of data items.

A verifying party can prove that a certain data item was exchanged between the sending and receiving party. To do so, the verifying party obtains the on-chain Merkle root and performs a Merkle proof using the data item. The verifying party may be the sending party, the receiving party, or a third party.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 schematically illustrates an example payment channel protocol,

FIG. 4A schematically illustrates an example Merkle tree,

FIG. 4B schematically illustrates an example Merkle proof,

FIG. 5 is a schematic block diagram of an example system for implementing a data exchange protocol,

FIG. 6 schematically illustrates how an evolving Merkle tree develops through multiple data exchange iterations,

FIG. 7 schematically illustrates another example Merkle proof,

FIG. 8 schematically illustrates an example data exchange protocol,

FIG. 9 schematically illustrates another example Merkle proof,

FIG. 10 schematically illustrates another example Merkle proof,

FIG. 11 schematically illustrates an example data exchange protocol for each phase of a multi-party setup,

FIG. 12 schematically illustrates the evolution of a Merkle Tree for two separate computing parties, and

FIG. 13 schematically illustrates an example data exchange protocol orchestrated by an Oracle for two separate computing parties.

### DETAILED DESCRIPTION OF EMBODIMENTS

### 1. Example System Overview

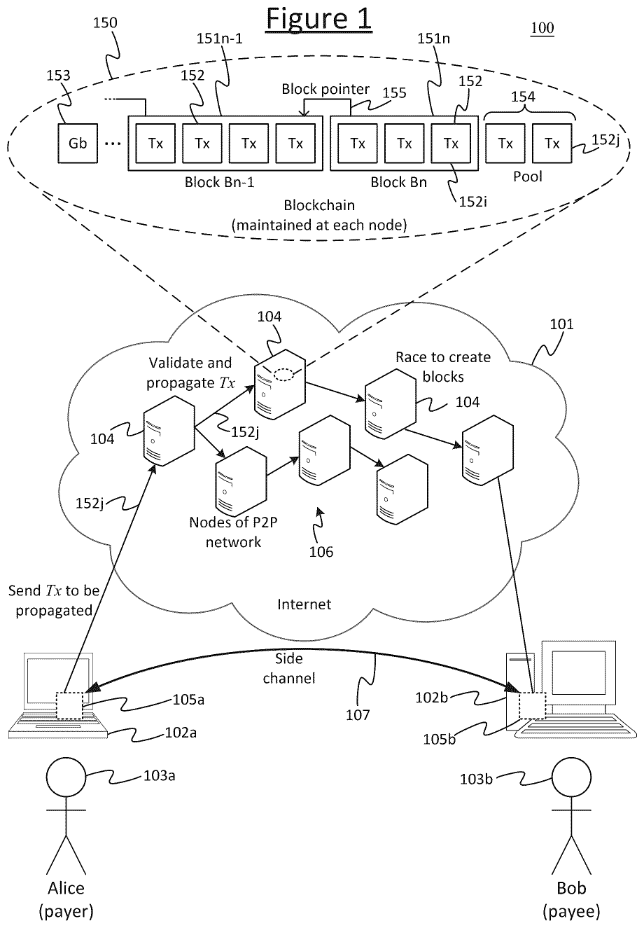

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”.

This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly.

In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

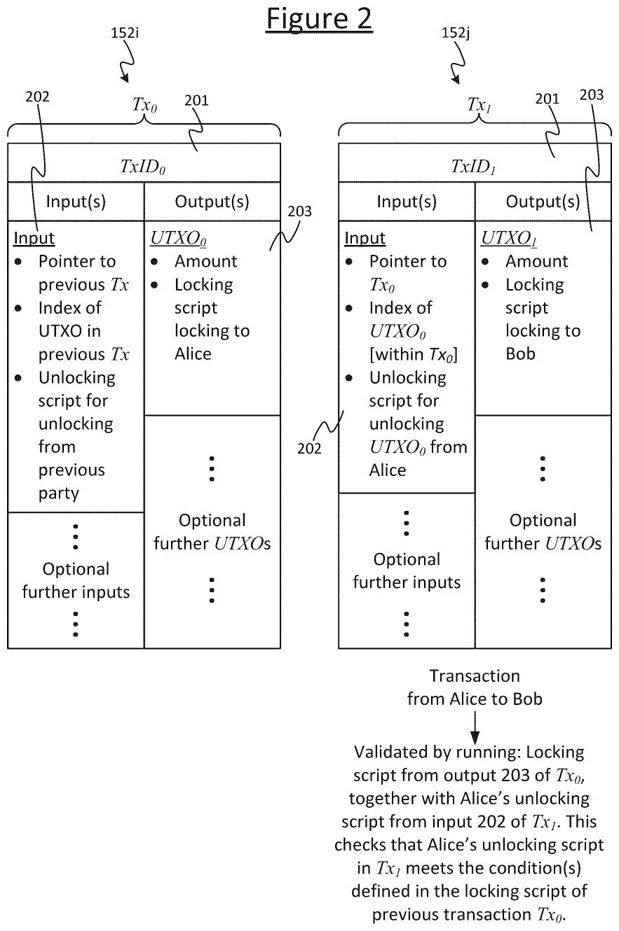

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}><P_{A}>∥[Checksig P_{A}]
   where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Payment Channels

In a blockchain context, the term “payment channel” (PC) is sometimes used to refer to a transactional channel established between multiple parties in a peer-to-peer (P2P) fashion. The PC includes a series of offline transactional promises or commitments between parties that do not require directly broadcasting to the blockchain with each update. PCs typically comprise two blockchain broadcasts:
1. An initial funding transaction, which is setup as a multi-signature transaction that commits funds to the PC,
2. A final settlement transaction, which finalises the distribution of the total initial funds in the funding transaction amongst the parties involved in the PC.

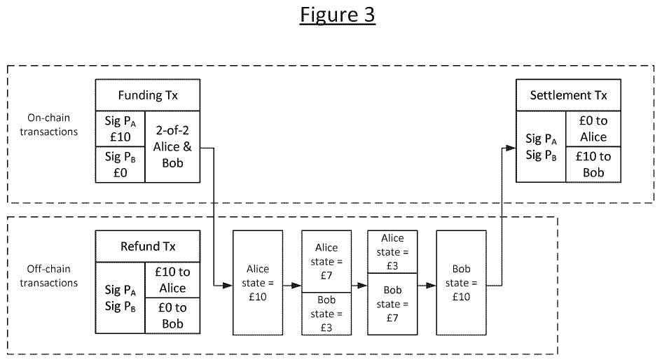

Between the submission of the funding transaction and settlement transaction, a series of ‘off-chain’ transactions can be created that effectively redistribute the initial committed funds (from the funding transaction) between the parties involved in the PC. These off-chain transactions equate to transaction commitments where each can theoretically be rendered ‘on-chain’ if confirmed by both parties. A refund transaction may also be created, whose purpose is to return the escrowed funds to the original owner according to the initial state, in the event that no further commitment transactions are created and signed. An example payment channel is shown in FIG. 3.

Enabling ‘off-chain’ commitment transactions in this way allows for far more cost-effective repeated transactions. Performing n number of transactions ‘on-chain’ would incur n number of transaction fees. Whereas PC transaction fees are typically limited to just two instances (2×fee) of the fee being paid for the funding transaction and the settlement transaction, regardless of the number the number of payments to the recipients that need be made. This allows greater scalability and makes transactions involving micro-payments feasible.

Further, PC transactions are also more time efficient. An off-chain commitment transaction can be sent to someone in milliseconds, whereas it would take around 10 minutes for a transaction to be confirmed on the blockchain. It could take an hour if waiting for the recommended 6 block confirmations of security, or more if the correct transaction fees were not paid.

A downside of operating within a PC is that the onus to keep track on the current state of commitments is on the parties involved. As multiple transaction states are constantly being updated it could be in the interests of one party to use a previous transaction commitment that reflects a state preferable to them. There are multiple mechanisms to ensure that these ‘bad actors’ are not successful in broadcasting a previous and therefore invalid commitment state, such as revocation contracts and time-lock and nSequence combinations.

### 5. Merkle Trees

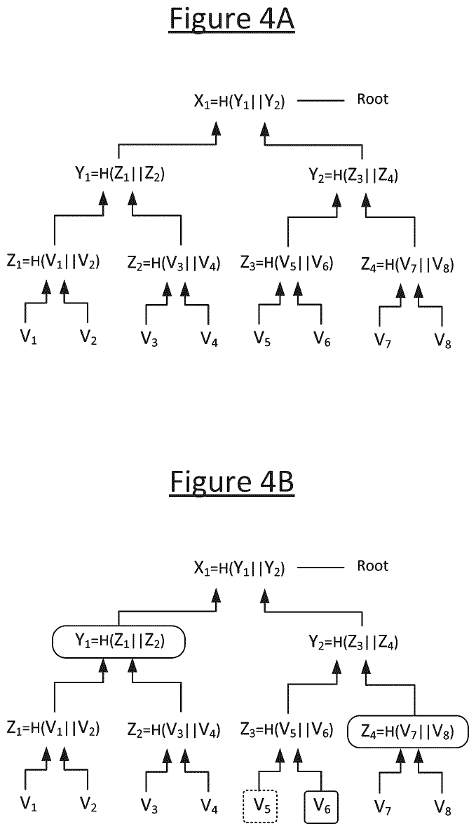

Merkle Trees are hash-based data structures that allow for the efficient verification of large amounts of data. An example of a binary Merkle tree is shown in FIG. 4A. As shown in FIG. 4A:
For the top layer, e.g. Root=X₁=Hash(Y₁∥Y₂).
For layer 1: Y₁=Hash(Z₁∥Z₂), Y₂=Hash(Z₃∥Z₄)
For layer 2: Z₁=Hash(V₁∥V₂), Z₂=Hash(V₃∥V₄), Z₃=Hash(V₅∥V₆), Z₄=Hash(V₇∥V₈

Where Y₁∥ Y₂ represents the concatenation of two separate strings Y₁ and Y₂.

The property of collision resistance in hash functions, particularly SHA-256, ensures that the Merkle root of a structure is a unique identifier of the set of Vᵢ values defined for that Merkle tree. This also means that only users with the knowledge of the set of Vᵢ values (or potentially a combination of the higher layer values Yᵢ, Zᵢ, etc.) can determine the Merkle root. The property of pre-image resistance of such hashing functions also ensures that the leaves cannot be derived from the Merkle Root.

Note that when a layer has an odd number of nodes, a dummy node (e.g. of value 1) may be added to make the layer even. The values, V₁, V₂, . . . , Vᵢ are now linked as an access chain to the Merkle root X₁. Where any change to the sequence or values would completely alter the root value derived from them.

Merkle tree proofs (or simply, Merkle proofs) are a method for efficiently demonstrating a data entry was used to derive the Merkle root. To do so it only requires a logarithm amount of data log₂ (N), where N represents the total number of data inputs. This provides an extremely compact and scalable verification tool, where any proof can be conducted to validate that some data was used prior to the formulation of the Merkle root. This is particularly interesting in the case of multi-signature transactions which utilise a Signature Tree. In this, the locking script would include the root of the Merkle tree and opcodes to verify the Merkle proof. The unlocking script would include the Merkle proof and one of the spending conditions.

For example, consider having a 1-of-8 multi-signature transaction. Each of the eight parties' public keys (PK) would represent a leaf node. It is likely that each of the PK's would be stored in the Merkle tree as a hashed value, to ensure privacy, so Vᵢ=Hash(PK_{user i}). As shown in FIG. 4B, if user 5 wished to provide a Merkle proof they would only require knowledge of their public key PK₅, V₆ (Hash(PK₆), Z₄ and Y₁. This provides a more efficient solution for proving a data entry than, say, a chained hash of all eight parties' public keys s as only a fraction of the number of stages are used in the proof.

In a 1-of-N multisig equivalent Merkle tree, the locking script generation steps are as follows:
1. Compute the hash of the public keys involved and put the hashes as the leaves of the tree, e.g., User 1 has public key P₁, let V₁=Hash(P₁)
2. Compute the Merkle Root
3. Form the following Locking script from the Merkle Root and n

### Locking Script:

OP_6 OP_PICK OP_SHA256 (OP_SWAP OP_IF OP_SWAP OP_ENDIF OP_CAT OP_SHA256)*n <Merkle Root>OP_EQUALVERIFY OP_CHECKSIG

The string (OP_SWAP OP_IF OP_SWAP OP_ENDIF OP_CAT OP_SHA256)*n represents the Merkle root derivation, which is performed n number of times. n is dependent on the number of levels within the Merkle tree. So for the derivation shown in FIG. 4B, there are 3 layers in the tree and therefore the above Merkle root derivation script is carried out 3 times, i.e. n=3.

The unlocking script would comprise: signature, PK, and Merkle proof, where the Merkle proof will comprise (<sibling_node><direction>)*n. ‘Sibling node’ defines the hash value of the other paired node which share the same direct parent node. As one moves through the Merkle proof path, the direction defines whether the sibling is to the left (0) or to the right (1). For example, User 5 with Public key P₅ would provide the following unlocking script:

### Unlocking Script:

<Sig><PK₅><Y₁><0><Z₄><1><V₆><1>

The unlocking and locking script would behave as follows on the stack:

| Main Stack | Script |
|---|---|
| | <Sig><PK₅><Y₁><0><Z₄><1><V₆><1> |
| | OP_6 OP_PICK SHA256 (OP_SWAP OP_IF |
| | OP_SWAP OP_ENDIF OP_CAT |
| | OP_SHA256)*3 <Merkle Root> |
| | OP_EQUALVERIFY OP_CHECKSIG |
| <Sig><PK₅><Y₁><0><Z₄><1><V₆><1> | OP_6 OP_PICK SHA256 (OP_SWAP OP_IF |
| | OP_SWAP OP_ENDIF OP_CAT |
| | OP_SHA256)*3 <Merkle Root> |
| | OP_EQUALVERIFY OP_CHECKSIG |
| <Sig><PK₅><Y₁><0><Z₄><1><V₆><1> | SHA256 (OP_SWAP OP_IF OP_SWAP |
| < PK₅ > | OP_ENDIF OP_CAT OP_SHA256)*3 |
| | <Merkle Root> OP_EQUALVERIFY |
| | OP_CHECKSIG |
| <Sig><PK₅><Y₁><0><Z₄><1><V₆><1> | (OP_SWAP OP_IF OP_SWAP OP_ENDIF |
| < V₅ > | OP_CAT OP_SHA256)*3 <Merkle Root> |
| | OP_EQUALVERIFY OP_CHECKSIG |
| <Sig><PK₅><Y₁><0><Z₄><1><Z₃> | (OP_SWAP OP_IF OP_SWAP OP_ENDIF |
| | OP_CAT OP_SHA256)*2 <Merkle Root> |
| | OP_EQUALVERIFY OP_CHECKSIG |
| <Sig><PK₅><Y₁><0><Y₂> | (OP_SWAP OP_IF OP_SWAP OP_ENDIF |
| | OP_CAT OP_SHA256) <Merkle Root> |
| | OP_EQUALVERIFY OP_CHECKSIG |
| <Sig><PK₅><X₁> | <Merkle Root> OP_EQUALVERIFY |
| | OP_CHECKSIG |

If correct, accepted.

| | |
|---|---|
| <Sig><PK₅> | OP_CHECKSIG |

If signature corresponds to PK, unlocked.

### 6. Data Exchange Protocol

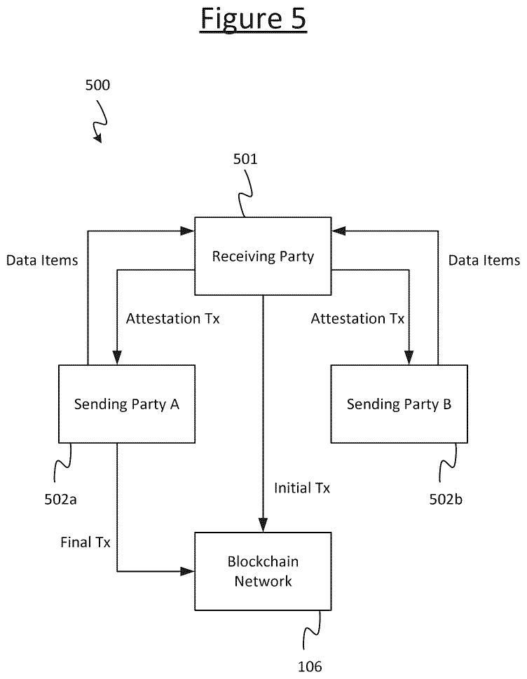

FIG. 5 illustrates an example system for implementing the embodiment described herein. The system 500 comprises a receiving party 501 and one or more sending parties 502. Two sending parties 502a, 502b are shown in FIG. 5, but in general the system 500 may comprises any number of receiving parties. The system 500 further comprises one or more nodes 104 or a blockchain network 106. For brevity, the receiving party will at times be referred to as Alice 501. Similarly, a first one of the sending parties will at times be referred to as Bob 502a, and a second one of the sending parties as Charlie 502b. The sending party 502 may be configured to perform any action described above as being performed by Alice 103a and/or Bob 103b and operate their respective computing equipment. Similarly, any sending party 502 may be configured to perform any action described above as being performed by Alice 103a and/or Bob 103b and operate their respective computing equipment.

Each sending party 502 is configured to send one or more data items to the receiving party 501. The data items may be any form of data, e.g. text, strings, documents, images, audio files, video files, software, etc. The receiving party 501 is configured to receive data items from the sending parties. The receiving party 501 receives a sequence of data sets, i.e. a sequence of sets of data items. Each set includes one or more data items. That is, a set may consist of a single data item, or be made up of multiple data items. Each data set may contain the same number of data items, or some data sets may contain different numbers of data items. In some examples, each data set is sent by the same sending party 502. In other examples, multiple sending parties may send data sets to the receiving party 501.

Each time the receiving party 501 receives a data set, the receiving party 501 creates a Merkle tree using all of the received data items. That is, when the receiving party 501 receives a first data set, a first Merkle tree is created using the data items in the first data set. Then, when the receiving party 501 receives a second data set, a second Merkle tree is created using the data items in the first data set and the data items in the second data set. Similarly, when the receiving party 501 receives a third data set, a third Merkle tree is created using the data items in the first data set, the data items in the second data set, and the data items in the third data set. The process continues in a similar way as each new data set is received. The receiving party receives a sequence of data sets, and creates a sequence of Merkle trees. In this way, the original (i.e. first) Merkle tree is said to evolve as more and more data sets are received.

When creating a Merkle tree, the receiving party 501 hashes each data item, separately, and uses the resulting hashes as separate leaf nodes of the Merkle tree. That is, each data item in the first data set is hashed to form a respective leaf node of the first Merkle tree. Each data item in the first data and each data item in the second data set is hashed to form a respective leaf node of the second Merkle tree, and so on. The receiving party 501 may re-use one or more hash results rather than hashing each previously receiving data item each time a new Merkle tree is created. In other words, when creating the Merkle tree based on the second set of data items, rather than hashing each data item of the first set of data items to generate respective leaves of the Merkle tree, the receiving party 501 may use the same leaves that were used from the Merkle tree that was generated based on the first set of data items. Say the first Merkle tree was based on four data items, and the second Merkle tree was based on another four data items (eight in total), the receiving party 501 may re-use the four leaf hashes of the first Merkle tree as the first four leaf hashes of the second Merkle tree. The same applies to any of the Merkle trees, not just the first and second. In some examples, one or more leaf nodes may comprise a padding value, e.g. 0 or 1. This is so that the Merkle tree has an even number of leaf nodes.

Each Merkle tree has a respective Merkle root. The first Merkle tree has a first Merkle root, the second Merkle tree has a second Merkle root, and so on. Each time the receiving party 501 creates a Merkle tree, the receiving party 501 generates an attestation transaction (i.e. a blockchain transaction) that contains an output locked to the Merkle root of that Merkle tree. That is, the receiving party 501 receives a first data set, encodes the first data set into a first Merkle root, and locks an output of a first attestation transaction to the first Merkle root. Then, the receiving party 501 receives a second data set, encodes the second data set into a second Merkle root, and locks an output of a second attestation transaction to the second Merkle root. This process continues for each data set, creating a sequence of attestation transactions. In some examples, a previous attestation is updated to generate the next attestation transaction, rather than creating the next attestation transaction from afresh.

The output of a given attestation transaction may be locked to a Merkle root using any suitable technique. To be locked to a Merkle root means that the locking script requires an unlocking script of a spending transaction to include the Merkle root, or information for deriving the Merkle root when the locking script and unlocking script are executed together. For example, the locking script may comprise a hash puzzle based on the Merkle root. The hash puzzle includes a hash of the Merkle root. The unlocking script would then be required to include the Merkle root which, when hashed during script execution, produces the hash of the Merkle root. The produced hash would be compared with the hash that is included in the locking script.

In some examples, the receiving party 501 may include one or more respective hashes of one or more respective data items in one or more of the attestation transactions.

Each time the receiving party 501 generates an attestation transaction (i.e. a transaction locked to a new Merkle root), the receiving party 501 sends the attestation transaction to one or more of the sending parties 502. In some examples, each attestation transaction is sent to each sending party 502. In other examples, the attestation transaction is sent only to the sending party 501 that sent the latest data set in the sequence upon which the corresponding Merkle root is based. That is, the n^{th} data set is used to create the n^{th} Merkle root of the n^{th} Merkle tree, and the n^{th} transaction has an output locked to the n^{th} Merkle root. In this case, the n^{th} attestation transaction may be sent only to the sending party 502 that send the n^{th} data set.

The receiving party 501 may send each attestation to the one or more sending parties 502 before receiving the next data set. That is, the n^{th} transaction for the n^{th} data set may be sent prior to receiving the n+1^{th} data set.

In some embodiments, the receiving party 501 may also receive the Merkle roots of the Merkle trees from a sending party 502. The receiving party 501 may then use the received Merkle roots to lock the outputs of the attestation transactions. The Merkle roots may be generated by one or more of the sending parties 502. For instance, a single sending party 502 may have access to each data set and therefore is able to generate each Merkle tree. In other examples, different sending parties 502 may have access to different data sets, and those sending parties 502 may collaborate to generate one or more of the Merkle trees. The n^{th} Merkle root may be sent to the receiving party 501 by the same sending party 502 that sent the n^{th} data set to the receiving party 501.

Even though the receiving party 501 may receive one or more Merkle roots, the receiving party 501 may still calculate those Merkle roots. This may be done to enable the receiving party to ‘spot-check’ the sending party's work, e.g. their calculations or verifications. For instance, a sending party 502 may send one or more data items to the receiving party 501, along with a Merkle root of a Merkle tree formed using those data items. The receiving party 501 may then perform a Merkle proof on one or more of those data items to confirm that they do indeed belong to (i.e. are encoded by) the Merkle tree. The data item(s) for which a Merkle proof is performed may be selected at random. This reduces the number of ‘spot-checks’ the receiving party 501 has to do (e.g. one per set of data items). Furthermore, since the sending party 502 does not know which data item will be checked, the sending party 502 is incentivised to maintain a quality standard for each data item (e.g. each computation, verification, etc.)

In embodiments where the system 500 includes multiple sending parties 502, when the receiving party 501 receives a data set from one of the sending parties 502, the receiving party 501 may send a hash of each data item in the data set to each other sending party 502, i.e. the sending parties that did not send the data set. This is to ensure all parties can work from common Merkle tree, but only the sending party 502 who computed the value knows pre-image of the leaf hash (e.g. the data). In some examples, the receiving party 501 also sends the hashes to the sending party 501 that did send the data set. The sending receiving party 501 sends a separate hash of each data item, rather a hash of the data items combined. E.g. if the data set includes three data items, the receiving party 501 sends three hashes. This allows the sending parties 502 that do not have access to the data items sent by the other sending party 502 to still be able to generate the Merkle root(s) of the Merkle tree(s).

The receiving party 501 may choose to only send the hashes to the sending parties 502 in response to the sending parties signing the attestation transaction whose output is locked to the Merkle root of the Merkle tree generated based on the data items corresponding to the hashes. That is, the n^{th} attestation transaction is locked to the n^{th} Merkle root of the n^{th} Merkle tree generated based on the n^{th} data set (and the previous data sets). The receiving party 501 may send the n^{th} attestation transaction to one or more sending parties 502, and require the one or more sending parties 502 to sign the n^{th} attestation transaction before sending the hashes of the data items in the n^{th} data set to those one or more sending parties 502.

In some embodiments, the attestation transactions may be sent as part of a payment channel. In this case, the receiving party 501 first generates an initial transaction. The initial transaction has an output locked to the public key of the receiving party 501. The output may also be locked to a respective public key of each sending party 502. Each attestation transaction includes an input that references the output of the initial transaction. The receiving party 501 includes, in the input of each attestation transaction, a signature generated with a private key corresponding to the receiving party's public key. The initial transaction is sent to the blockchain network 106 and/or to one or more of the sending parties 502. The sending parties may be required to sign the initial transaction before it is sent to the blockchain, either by the receiving party 501 or the sending parties 502.

The data exchange protocol will now be described from the perspective of a sending party 502. In the scenario where there is a single sending party 501, the sending party sends a set of data items to the receiving party and generates a Merkle tree based on those data items. In response to receiving an attestation transaction, the sending party 501 may generate a final transaction. The final transaction includes an input that references the output of the attestation transaction and includes the Merkle root for unlocking the output. The final transaction is sent to the blockchain network 106, either directly by the sending party 501, or via the receiving party 501. As mentioned above, in some examples the sending party 502 may generate the Merkle root and send the Merkle root to the receiving party 501, e.g. so that the receiving party 501 can spot-check one or more of the data items.

Note that the “final transaction” refers to the transaction that spends an output of the attestation transaction and in doing so reveals the Merkle root. The final transaction is not to be confused with a final one of the attestation transactions, which may be the attestation transaction that is referenced by the final transaction.

The attestation transaction that is referenced by the final transaction may be the first attestation transaction generated by the receiving party 501, or a later one of the attestation transactions. That is, the sending party 502 may send a sequence of respective data sets to the receiving party 501 and generate a respective Merkle tree for each respective data set, where the Merkle tree is based on the respective data and set and each previous data set in the sequence. The sending party 502 receives a respective attestation transaction for each data set. The sending party 502 chooses which attestation transaction to unlock using the final transaction. That is, the sending party 502 chooses the output of a particular attestation transaction to reference with the input of the final transaction, and includes the Merkle root of the Merkle tree that will unlock that output. The sending party 502 will typically choose to unlock the output of the latest attestation transaction.

Now considering the case where there are multiple sending parties 502, e.g. a first sending party 502a and a second sending party 502b. Each sending party 502 sends respective data sets to the receiving party 501. The respective data sets form a sequence of data sets. When a sending party 502 sends the latest data set in the sequence, the sending party 502 may receive an attestation transaction from the receiving party 501. When a sending party 502 does not send the latest data set in the sequence (i.e. the latest data set was sent by a different sending party 502), that sending party 502 may also receive the hashes of the data items in the set. This may be conditional on the sending party 502 signing the attestation transaction. The sending party 502 may use the received hashes in order to generate a Merkle tree based on the next data set. This is so that the sending party 502 can work from the same common Merkle tree and add future data entries (leaf nodes) to generate the next version of the Merkle tree.

The system 500 may also include a verifying party (not shown). The verifying party may be a distinct party, or it may be the receiving party 501 or one of the sending parties 502. The verifying party has access to a data item and would like to verify that it was exchanged between a sending party 502 and the receiving party 501. The verifying party obtains the final transaction from the blockchain 150 and extracts the Merkle root. The verifying party then verifies that the data item was used to generate the Merkle root by performing a Merkle proof. The verifying party may have access to the inner hashes of the Merkle tree, or the verifying party may receive them from the receiving party 501 and/or one of the sending parties 502.

### 7. Merkle Index Root

This section provides further examples of the described embodiments.

Blockchains allow information to be stored on-chain in an immutable manner, but transaction fees and low latency make incremental data transfer and storage impractical. Utilising payment channels (PCs) to this end can remove such issues, allowing high frequency data exchange and only requiring a fee to be paid when the PC is opened and closed on-chain. However, PCs are P2P, with exchanges occurring off-chain removing any means to verify that some data was stored correctly.

Embodiments use a Merkle tree as a mechanism within a PC to provide a means to exchange and store data. Locking an output to the Merkle root formed from the data that is exchanged off-chain provides a guarantee for the data computed and transmitted when this PC is settled on-chain. This also provides increased functionality and added layer of security between the sending and receiving parties.

A computing party 502 is given some amount of funds, via off-chain commitment transactions, by a funding party 501 for performing some computation and transmitting this computation to the funding party 501. Computations involve the execution of some work to create a data output. This can be a computation, verification, or data collection for example. The data being computed and exchanged in the PC forms the pre-image data entries (leaf nodes) in the Merkle tree, that is common to both funding and computing parties. The Merkle root defined from these data-entries is then used in the locking script. If any party wishes to settle the PC, they must reveal the Merkle root on chain. This ensures that any party with knowledge of the pre-image data can verify that some data was computed and stored correctly within the off-chain PC that formed the Merkle tree.

Locking commitment transactions to the Merkle root formed from the multiple data computations ensures the computing and funding parties have common data throughout the evolution of the PC and no communication errors occurred. They also provide an efficient means to authenticate the sequence of computations and commitment transactions that relate to those computations. Once the Merkle root is published on chain, a Merkle proof may be performed to allow efficient verification that some data was included in the computed Merkle tree, without necessarily revealing the other data.

### 7.1 Evolving Merkle Tree-Single Channel

As computations are exchanged within the PC, both parties 501, 502 iteratively increase the capacity of a Merkle tree to incorporate new values. This is referred to herein as an “evolving Merkle tree”. Each time a computing party 502 sends computed data to the funding party 501, the data entry is added to the evolving Merkle tree which increases the number of leaves, and eventually the number of layers. With each additional data entry, the Merkle root will also change. This property can be used to continually update locking scripts for new commitment transactions within the PC. As stated, if any party wishes to settle the PC, they must reveal the pre-image Merkle root on chain to unlock the funds, which then allows any party, with knowledge of the pre-image data, to verify that data was correctly recorded in the Merkle root.

Consider one way PCs, in which funds are awarded for some amount of work such as: computations, data verification or data collection and storage. The data computed and sent from the computing party 502 to the funding party 501 is entered as the pre-image leaf node entry in a Merkle tree. The relevant commitment transaction (i.e. attestation transaction) awarded to the computing party for this is locked to the hashed Merkle root from this entry.

In these examples, the first stage involves establishing a (initial) funding transaction between Alice 103a (receiving party 501) and Bob 103b (sending party 502). The funding transaction has inputs from both parties and a 2-of-2 multi-signature output, as shown in the example transaction below:

Funding Transaction, TxID_{F}

| Input list | | Output list | |
|---|---|---|---|
| Value | Script | Value | Locking script |
| 10 BSV | < Sig_{A} > | 11 BSV | OP_2 <P_{A}> <P_{B}> OP_2 |
| | < PK_{A} > | | OP_CHECKMULTISIG |
| 1 BSV | < Sig_{B} > | | |
| | < PK_{B} > | | |

This transaction is published on-chain for the commitment of funds to the PC. It is not necessary that the computing party, Bob 103b, dedicate funds to the PC but may be required by Alice 103a to ensure his commitment.

A refund transaction may also be created, whose purpose is to return the escrowed funds to the original owner according to the initial state. This is only published to the blockchain 150 if no further commitment transactions are created and signed. An example refund transaction is shown below.

Refund Transaction, TxID_{R}

| Input list | | Output list | |
|---|---|---|---|
| Value | Script | Value | Locking script |
| 11 BSV | < Sig_{A} >< PK_{A} > | 10 BSV | OP_DUP <P_{A}> |
| | | | OP_EQUALVERIFY |
| | < Sig_{B} >< PK_{B} > | | OP_CHECKSIG |
| | | 1 BSV | OP_DUP <P_{B}> |
| | | | OP_EQUALVERIFY |
| | | | OP CHECKSIG |

From here, a series of ‘off-chain’ transactions are created. These off-chain commitment transactions are sent from the funding party Alice 103a to the computing party Bob 103b for computed data. Linking the exchanged and computed data to a Merkle tree allows for efficient verification that some data entry was computed and stored during the off-chain activity in the PC, once settled on-chain. This can be done without explicitly revealing other data entries, as we can use the hashed forms of other data entries for proofs.

Further, for such arrangements, locking commitment transaction outputs to Merkle Tree roots ensures a dependency for the unlocking party to have received and/or stored all the previous computations, adding a layer of security and work requirement for anyone trying to access the funds. The commitment transactions may appear as shown below.

Commitment Transaction i, TxIDᵢ

| Input list | | Output list | |
|---|---|---|---|
| Value | Script | Value | Locking script |
| 11 BSV | < Sig_{A} >< PK_{A} > | 11 − iN | OP_DUP <P_{A}> |
| | < Sig_{B} >< PK_{B} > | BSV | OP_EQUALVERIFY |
| | | | OP_CHECKSIG |
| | | 1 + iN | OP_DUP OP_SHA256 |
| | | BSV | <H(Merkle Rootᵢ)> |
| | | | OP_EQUALVERIFY |
| | | | OP_DUP <P_{B}> |
| | | | OP_EQUALVERIFY |
| | | | OP_CHECKSIG |
| | | 0 BSV | OP_0 OP_RETURN |
| | | | <V₀ − Vᵢ> |

Referring to the transaction above:
i is the commitment transaction index,
N is the fixed amount to be rewarded for each computation,
Merkle Rootᵢ is the Merkle Root derived from i computations,
V₀−Vᵢ represent any hashed leaf node data that the funding party may want public once settled.

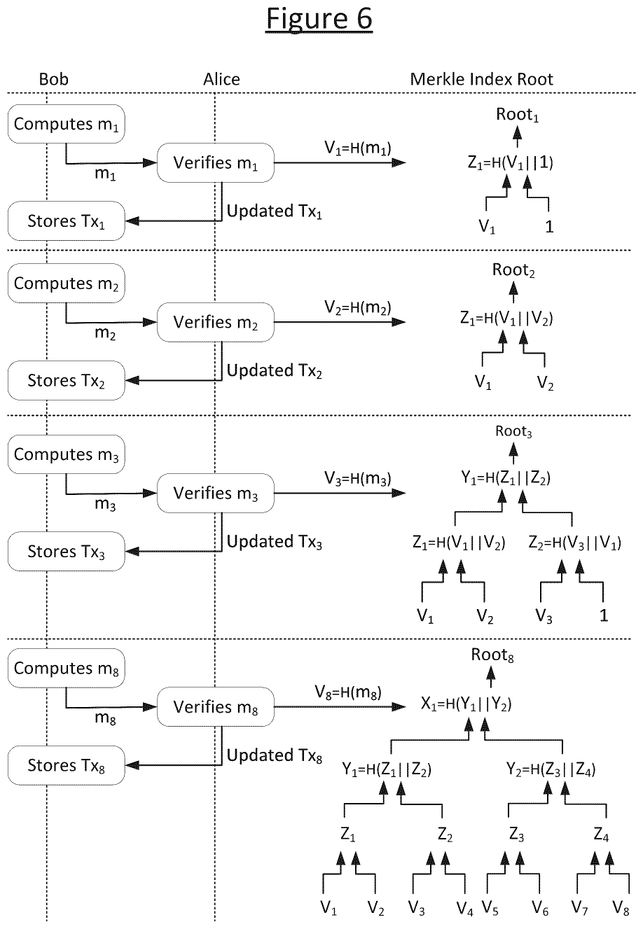

FIG. 6 outlines how the evolving Merkle tree may develop through the cycle of multiple commitment transactions within a PC. It can be summarised as follows:
Bob computes mᵢ and sends to Alice,
Alice verifies mᵢ and adds the value to the Merkle tree,
Alice creates an updated commitment transaction Txᵢ, locked to the hash of the new Merkle Root and Bob's address,
Alice sends Txᵢ to Bob who can unlock and broadcast it on-chain at any time,
This is repeated for multiple computations and so the Merkle tree evolves as shown.

Locking commitment transactions to the hashed Merkle roots in this way ensures that the data being computed and exchanged in the off-chain stage of a PC is always structured as a Merkle Tree. If at any time the PC is settled, the Merkle root for this tree is revealed on-chain, allowing any party with some knowledge of the tree to verify some data was computed and exchanged in the off-chain stage of the PC. ‘Some knowledge’ refers to some hashed forms of the other data within the tree, which may be stored within the outputs of commitment transactions using OP_RETURN.

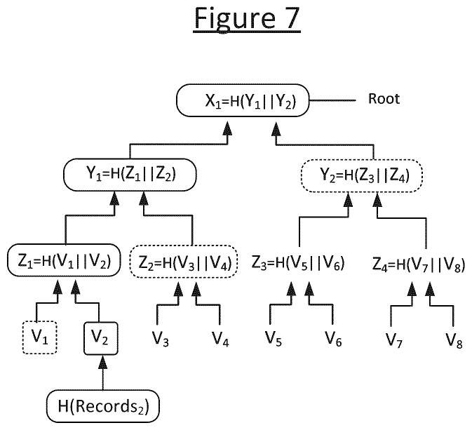

For example, assume that a company wanted to collect some records from several different departments within that company. They outsource this data collection to an auditor who wishes to perform the work incrementally within a PC, to save money and time whilst minimising risk they won't be paid for some amount of work. The PC occurs between the company's executive team and the outsourced auditor, not with the departments themselves. Commitment transactions are sent to the audit team by the executive team as data is collected and exchanged. Each updated commitment transaction output is locked with the hashed Merkle root referencing all the exchanged data up until that point. As these commitment transactions are sent off-chain within the PC, it is not possible to rely on the immutable properties of blockchain to verify this data was stored correctly. The above protocol ensures that parties have an efficient method for verifying data was stored correctly in a Merkle tree when the PC is settled on-chain. If one of the departments wanted to verify that some data entry was submitted correctly during data collection, they could perform a Merkle proof using the pre-image of those records for the on-chain Merkle root, and some hashed information for the rest of the tree. If department number 2 wanted to verify the set of data records were stored correctly, they could perform a Merkle proof as shown in FIG. 7. With only pre-image knowledge of the 2^{nd} set of records, they need the hashed values V₁, Z₂ and Y₂, along with the on-chain root to ensure that the data was entered and stored correctly in the right sequence. This is an efficient way of proving a set of data was used in a large set of data, without revealing any of the other pre-image data.

A benefit of this protocol is that it provides a mechanism for verifying the data transferred between parties in the off-chain stage of a PC. It also provides the following additional benefits:
Additional security—It ensures that only an individual who has the Merkle root, formed from knowledge of all data entries (e.g. computations) can access the funds being locked in each transaction commitment. This can ensure that only a party who has done the necessary work involved can access the funds. For the example above it means that only the computing party, who has computed and stored all computations, can claim the funds locked by the funding party. This could be particularly critical when there are multiple parties attempting to claim funds.
Transmission verification—This protocol also ensures that the same messages, mᵢ, have been correctly submitted and stored by both funding and computing parties. If the computing party sends messages m₁, m₂ and m₃ to the funding party. The funding party will submit m₁, m₂ and m₃ into the Merkle tree and derive the Merkle root from these values. The transaction commitment sent to the computing party by the funding party will be locked using this Merkle root. The funds can only be unlocked if both the funding and computing parties' Merkle roots are the same, which as described above can only occur if the values and sequences for m₁, m₂ and m₃ are the same.
Spot check—The Merkle proof also allows the funding party to perform irregular spot checks on multiple computations being performed by the computing party. For example, rather than verifying each data entry as they are sent across, the funding party may routinely perform a Merkle proof of previous entries to verify data.

### 7.1.1 Evolving Merkle Index Root Use Case 1—PC Verifiable Data Storage

Alice 103a is an online game manager and Bob 103b runs one of the online games. Alice 103a wishes to store all data relating to the games regularly on the blockchain 150 but knows the associated fees and latency would make this impractical to do for each round or game of poker. Alice wishes to use a PC with Bob to exchange data about each round of a game. Bob works on commission, so he receives some amount of funds per round that he records within the PC. The funding and settlement transactions are the only stages of a PC that are shown publicly on chain. However, the information being transferred by Bob to Alice represents the states of rounds which involved the players, who are not Alice and Bob. These parties may wish to verify that states were recorded properly, and as these parties are not involved within the PC, they need a mechanism for doing so. Further, some private information for other parties should not be revealed in the verification process e.g., players may not want their cards revealed to other players. In this example, there is 1 round of the game and 6 players within an online game. There would likely be many rounds in a real-world example. The formulation, evolution and settlement of the PC representing this game of poker may look as follows:

V₀-V₆ represent the state of the player in that round, which may include:
Value of chips at start of the round,
2 cards dealt to the player,
Amount bet during the round.

V₇ represents the outcome of the game itself, which may include:
5 cards dealt to the table (if dealt),
Winner of the round.

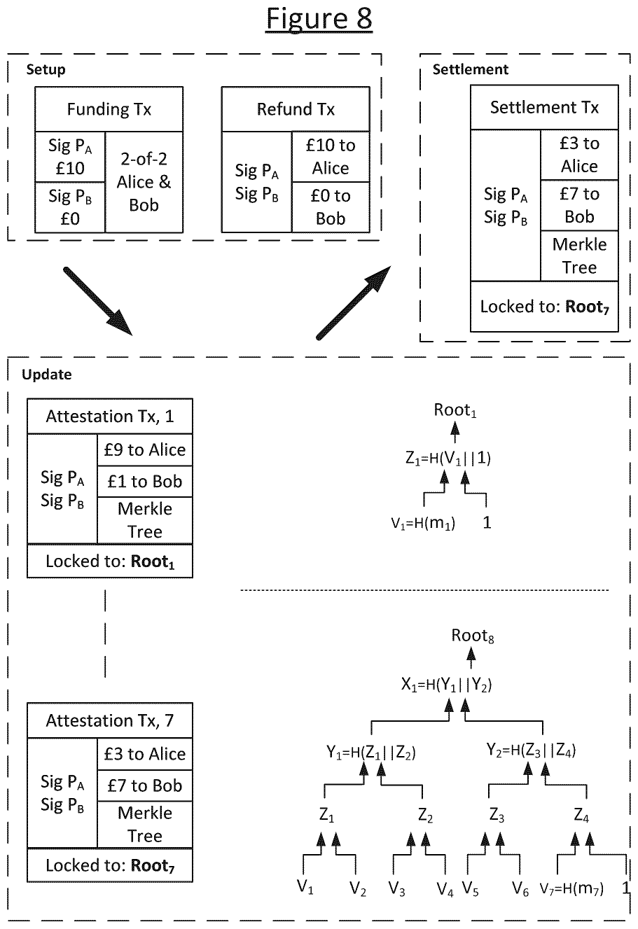

Locking the output of the commitment transaction with the hash of the Merkle Root; in this way ensures that the data entry sequence V₀-V₇ have been acknowledged and maintained by the officiating parties, Alice and Bob. Once the game is finished and the settlement transaction broadcast on chain, the players can verify their states were recorded properly by Alice and Bob off-chain in the PC. In this example they may also verify that the game outcome, V₇, was recorded properly. This is done using a Merkle proof of the pre-image data in the correct sequence and some hashed values for the rest of the Merkle tree, which may be made public off-chain on some shared platform, or via a transaction output utilising OP_RETURN. Further, this may be done without revealing any pre-image information about other players states. FIG. 8 illustrates an example of this protocol for implementing this use case.

### 7.1.2 Evolving Merkle Index Root Use Case 2—PC Computations Partially Trusted Party

This use case considers a computation outsourcing arrangement. Alice 103a wishes to outsource a series of computations to Bob 103b. Bob wishes to receive some amount of funds per computation as a precaution in case Alice refuses to pay for some work. Bob could send across each computation, which is then verified by Alice before she sends an updated commitment transaction within the PC. However, let's assume Alice and Bob partially trust each other, as they have worked together before, and Bob has proven to be reliable. Both parties wish to speed up the process of sending all of these computations. Bob doesn't trust Alice sufficiently to send all computations in one batch and Alice doesn't trust Bob sufficiently to not have some incremental verification protocol.

This interaction may assume that the computations are hard to solve, but easy to verify. An example is to consider hashing a set of data to below a certain difficulty threshold, as would be done for proof-of-work activities (bitcoin mining). We assume that Alice wants Bob to compute the hash values for a series of data sets using a variable nonce and ensuring all hash values are below a certain difficulty threshold. We summarise this use case as follows: Alice wants Bob to compute 1000 hash values, mᵢ, below a certain difficulty threshold using a nonce. Alice will setup a PC in which she can incrementally pay Bob. Alice will allow Bob to compute the values in groups of 8, forming a Merkle tree from these groups. So, the first group will contain elements m₁-mg and the second group will contain elements m₉-m₁₆. Note that the tree will continually expand so that the first Merkle tree of group one is compounded with group two, to create a Merkle tree of 16 elements.

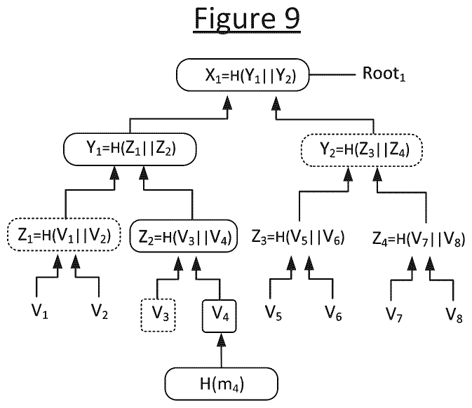

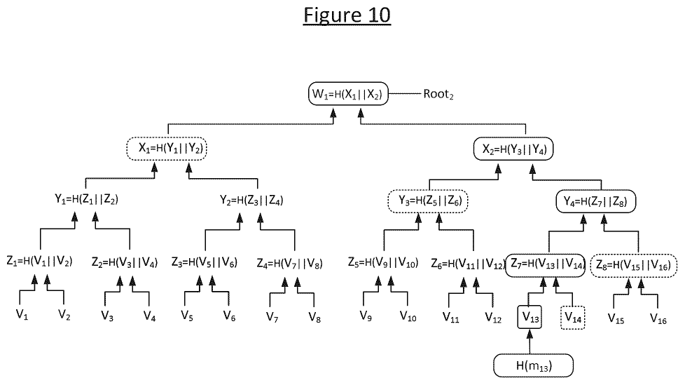

The process may go as follows:
Alice may setup a funding transaction with Bob to dedicate some amount of funds to the PC. She may specify the computations required and the rewards per computation set. They agree on the number of computations exchanged per commitment transaction reward. Bob and Alice agree to 8 elements per group.
Bob computes the first group of elements m₁-m₈ and the Merkle Root₁ and sends these to Alice.
Alice receives these and performs a Merkle proof on a random pre-image data entry to verify it. As shown in FIG. 9, Alice has randomly chosen to verify m₄ and ensure that the Merkle Root₁ Bob has sent her corresponds to the values and sequence sent. This random verification means that Bob will ensure that all computations are done correctly as Bob cannot know which value will be checked.
After verification, Alice sends Bob the commitment transaction with locking script related to Bob's public key and the hash of Merkle Root₁. She may also include the hashed data values V₁-V₈ for the Merkle tree in an output containing the OP_RETURN code.
Bob then proceeds to compute the second group of 8 values. He combines these with original group to ensure that the groups are chained together in one Merkle tree. As Alice and Bob both have values m₁-mg already, Bob only needs to transmit values m₉-m₁₆ and the new Merkle Root₂.
Alice receives these and performs a Merkle proof on a random pre-image data entry to verify it as before. As shown in FIG. 10, Alice has chosen to verify m₁₃ from this new group. They perform the Merkle proof on this to ensure that the Merkle root Bob has sent her corresponds to the values and sequence has sent.
After verification of m₁₃ computation and Merkle Root₂ are completed Alice sends the updated commitment transaction with locking script related to Bob's public key and the hash of Merkle Root₂. She could also include the post-hash data values for the Merkle Tree in an output containing the OP_RETURN code.

This process will be continued until m₁₀₀₀ entries have been computed and transmitted from Bob to Alice. At which point the Merkle tree and root is final. Alice may then create the final settlement transaction with locking script:
OP_SHA256<H (Merkle Root₁₂₅)>OP_EQUALVERIFY<PK_{B}>OP_CHECKSIGVERIFY

As Bob has the entire Merkle tree, he can calculate the final (125th) Merkle root and push this into the unlocking script along with his signature and public key as follows:
<Sig_{B}><PK_{B}><Merkle Root₁₂₅>

This allows Bob and Alice to minimise the number of commitment transactions exchanged with Alice significantly, making the process more efficient. Further, Alice may perform the Merkle proof at random with each group, to ensure that Bob is performing the computations correctly. This ensures a level of security as Bob does not know which value Alice will verify and therefore ensures all computations are carried out correctly to guarantee funds.

Locking the commitment transaction with the hash of the Merkle Rootᵢ in this way ensures that the data entry sequence V₀-Vᵢ have been acknowledged and maintained by both computing and funding party. Then any stakeholders with data pertaining to the computations and Merkle tree may ensure their data was computed/stored against the Merkle root revealed in the unlocking script. Hashed data may be stored publicly by creating an output in the commitment/settlement transaction that stores the hashed leaf values and sequencing with the OP_RETURN op code.

### 7.2 Evolving Merkle Index Root-Multi-Channel

The example use cases above have considered a single 1-to-1 PC relationship, in which one party is the funding party 501 and the other is the computing party 502. The relationship is one way, with the computing party 502 transmitting data in return for funds distributed within the PC. In other scenarios, there are multiple computing parties 502 operating for the payment(s) from one funding party 501. This may be the case for sub-contractors of a single entity, as will be discussed in the use case. In such cases the evolving Merkle tree ensures that as the computations are carried out and exchanged, all parties are working from a common Merkle tree solution, allowing them to easily verify data entries.

As before, the funding party 501 may establish a funding transaction with a multi-signature output including all computing parties. The computations may be competitive, in which case there is a ‘race’ to compute values which may only require a 2-of-3 multi-signature arrangement. However, computations could also be considered cooperative. In such cases a 3-of-3 multi-signature agreement may be utilised to ensure that both parties have acknowledged the most recent state update and therefore have the most recent Merkle tree and Merkle root to update the script with.

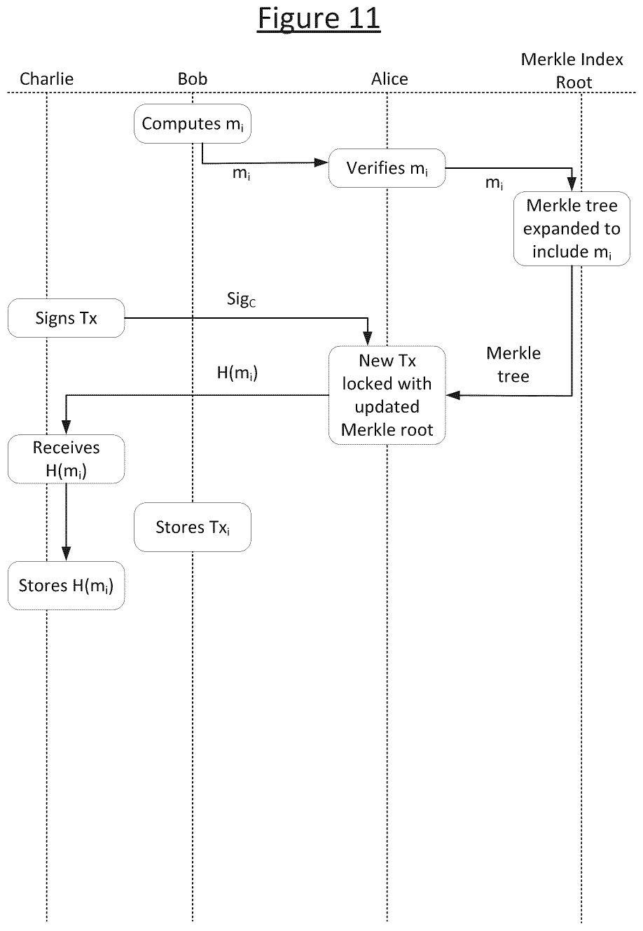

Consider two computing parties Bob 502a and Claire 502b, working with funding party Alice 501. As shown in FIG. 11, Bob 502a computes one of the values mᵢ and sends this to Alice 501a who verifies it. Once verified Alice 501a adds the value to her Merkle tree and updates the Merkle root accordingly. She then generates a commitment transaction awarding Bob 502a additional funds for computing this value. For Bob 502a to use this transaction he still needs Claire's signature, which may be assured by only revealing the hashed version of Bob's computation mᵢ when Claire 502b signs the commitment transaction. Bob 502a, Alice 501 or an automated oracle function may perform this functionality.

For example, Alice 501 may generate the transaction, sign it and then send it to Claire 502b to be signed. It is in the interests of Claire 502b to sign the commitment transaction and send it back to Alice 501 and/or Bob 502b, as in return these parties can reveal the hashed version of the previous computation performed by Bob H(mᵢ). Claire 502b needs this value to continue working on the common Merkle tree that defines this PC. She could try to compute the value herself, but it is likely that it would be less work to simply sign the commitment transaction and receive the value off-chain. She can then begin the work to compute the next computation to try and earn funds from Alice 501.

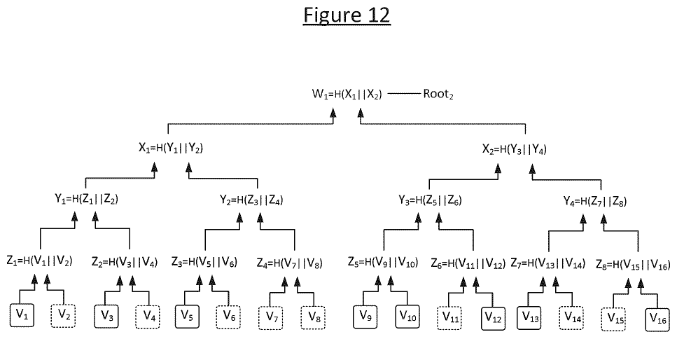

The reason for choosing to reveal only the hashed version of mᵢ is twofold. Firstly, the pre-image data may be sensitive and therefore may not be suitable for being explicitly revealed to Claire 502b, for example. Further, it ensures that only Bob 502b can provide the Merkle proof for this data entry, if he was the only one who was successful in the computation. This computation, verification and signature process can work in any direction for both Bob 502a and Claire 502b and as such the evolving Merkle tree is common to all parties as it progresses. In FIG. 12, inputs in dashed squares represent those computed by Bob 502a and inputs in solid line squares represent those computed by Claire 502b.

This protocol allows for sequencing, locking, and unlocking transactions within a PC for multiple parties. The protocol allows any party with pre-image data to verify that data was stored and utilised within the Merkle tree formed within the off-chain PC. This may also allow parties not involved in the PC to verify that data was stored correctly once the PC has been settled on-chain.

Further, only a party that produced the pre-image computation may verify that data entry using a Merkle proof. This may be used to efficiently settle a dispute between parties who debate who computed one of the values in a Merkle tree. It would also not require the funding party to store all values of the data entries to do so. In this way, it also allows any user with knowledge of the pre-image data to verify their data has been stored correctly in the Merkle tree.

### 7.2.1 Evolving Merkle Index Proof Use Case 3—PCL Oracle Vaccine Data Storage

Alice runs a vaccine distribution company and wishes to outsource the data collection and uploading of vaccine data to multiple parties Bob and Claire. Unlike the previous example, this will form a 3-of-3 multi-signature transaction, where Alice, Bob and Claire will have to provide their signatures to transactions for them to be redeemable by either party. Bob and Claire both wish to receive some amount of funds per computation. In this example Bob and Claire's ‘computation’ will be a message containing a vaccines unique identifier, patient PK, data, time, location, a patient signature related to this message and a signature for the message from Bob/Claire who are the authenticating parties for the vaccine. Alice has a list of unique identification codes for the vaccines and a list of PK's for the vaccine recipients. Using these she can verify that the data being sent across is valid.

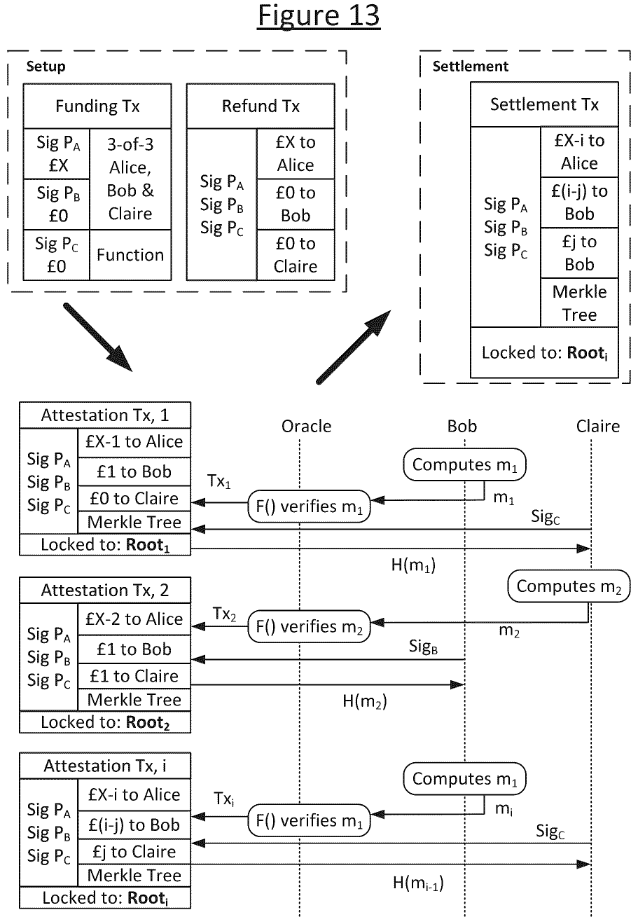

As the process is predictable Alice wishes to establish an Oracle automated PC for the commitment transactions. So far Alice has been consistently relied upon to perform the off-chain execution of the repeating code, which is the verification of transactions in the PC. The initial setup, PC and settlement may look as shown in FIG. 13. We now generalise the off-chain process and delegate it to the role of an oracle, which simply reads each successive transaction in conjunction with the initial funding transaction and executes some function to produce the next transaction. As the PC is off-chain it is acceptable to assume variables can be sent to the Oracle in a variety of formats.

In this example, the Oracle may receive computations mᵢ from Bob or Claire and verify them. Once verified the Oracle may update an internally stored Merkle Tree to include this computation and generate a commitment transaction linked to the hash of the Merkle Root formed, which may need to be signed by the other computing parties to be valid. In this example, the first computation m₁ is performed by Bob and sent to the Oracle. The oracle will verify this data. If valid, the Oracle will update its Merkle Tree and Root to include this value m₁. Then the Oracle will generate a transaction that:
a. Increases the amount of funds sent to Bob by 1 increment (reducing the funds returned to the Oracle),
b. Locks the commitment transaction related to signatures of Alice, Bob and Claire and the hash of the new Merkle Root,
c. Has an output containing Merkle Tree hashed data (via OP_RETURN).

As this is now a multi-party arrangement, the updated commitment transaction may then be sent to the other computing party Claire, who may generate a signature for it and send this back to the oracle. In return for Claire's signature, the oracle may release the hashed value H(m₁). Claire may need this value to continue operating within the PC and all future Merkle roots will be based on it.

Once the oracle has Claire's signature, it may send the commitment transaction to Bob, with both Alice's and Claire's signature. Bob could sign this commitment transaction and broadcast it to the blockchain at any time with his signature or continue to operate and profit within the PC alongside Claire.

As the process continues with each of Bob and Claire computing and transmitting data to the oracle, the Merkle tree grows. This would provide an effective way for the vaccine managers to efficiently verify that they have the pre-image vaccine data used in the Merkle Tree. As the pre-image data related to their PK and signature, this could be tied to a vaccine certification programme.

An additional benefit of locking commitment transactions in this way for multiple computing parties is that the data being computed is structured in a common Merkle Tree. As mentioned, fellow computing parties only require the hashed versions of data entries to continue working on the common Merkle Tree for future commitment transactions. This means that a party can verify they have computed a data entry at any time using a Merkle Index Proof of the pre-image data within the common Merkle Tree. This could be used to efficiently settle a dispute between parties who debate who computed one of the values in a Merkle Tree. For this example, it may be used to prove when and where a patient last received a vaccine. Accepting that the latest version of the data entry in the sequence is the most recent. It would also not require the funding party to store all values of the data entries to do so. In this way, it also allows any users with knowledge of the pre-image data to verify their data has been stored correctly in the Merkle Tree.

### 8. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of attesting to a sequence of data exchanges between a group, wherein the group comprises a receiving party and one or more sending parties, and wherein the method is performed by the receiving party and comprises:
receiving a sequence of two or more respective sets of data items, each respective set being sent by a respective sending party; and
for each respective set of data items in the sequence:
   generating a respective attestation transaction, wherein the respective attestation transaction comprises a respective output locked to a respective Merkle root of a respective Merkle tree, wherein the respective Merkle tree is based on the respective set of data items and each previous respective set of data items in the sequence; and
   sending the respective attestation transaction to at least the respective sending party that sent the respective set.

The respective attestation transaction may also be sent to the respective one or more sending parties that did not send the respective set, i.e. all sending parties.

Statement 2. The method of statement 1, wherein one, some or all of the respective sets of data items comprises a single data item.

Statement 3. The method of statement 1 or statement 2, wherein one, some or all of the respective sets of data items comprises multiple data items.

Statement 4. The method of any preceding statement, comprising:
for each respective set of data items in the sequence, sending a respective hash of each data item in the respective set to at least the respective one or more sending parties that did not send the respective set.

The respective hashes may also be sent to the respective sending party that did send the respective set, i.e. all sending parties.

Statement 5. The method of statement 4, wherein said sending of the respective hash of each data item is conditional on the respective one or more sending parties that did not send the respective set signing the respective attestation transaction.

Statement 6. The method of any preceding statement, wherein said sending of the respective attestation transaction comprises sending the respective attestation transaction to at least the respective sending party that sent the respective set prior to receiving the next respective set of data items in the sequence.

Statement 7. The method of any preceding statement, comprising:
for one or more respective sets of data items, generating the respective Merkle root of the respective Merkle tree.

Statement 8. The method of any of statements 1 to 6, comprising:
for one or more respective sets of data items, receiving the respective Merkle root of the respective Merkle tree from the respective sending party that sent the respective set.

Statement 9. The method of statement 8, comprising:
for at least one of the one more respective sets of data items, performing a Merkle proof for at least one of the data items in the respective set using the respective Merkle root.

Statement 10. The method of any preceding statement, comprising:
generating an initial transaction, wherein the initial transaction comprises an output locked to a public key of the receiving party and one or more additional public keys, each of the additional public keys being associated with a respective sending party, and wherein each respective attestation transaction comprises a respective input that references the output of the initial transaction and comprises a signature corresponding to the public key of the receiving party; and
sending the initial transaction to one or more nodes of the blockchain network and/or at least one of the one or more sending parties.

Statement 11. The method of any preceding statement, wherein the group consists of a single sending party.

Statement 12. The method of any of statements 1 to 10, wherein the group comprises multiple sending parties.

Statement 13. The method of any preceding statement, wherein the respective output of each respective attestation transaction is locked to the respective Merkle root of the respective Merkle tree by way of a hash puzzle.

Statement 14. The method of any preceding statement, wherein the respective attestation transaction comprises one or more respective hashes of respective data items upon which the respective Merkle tree is based.

Statement 15. A computer-implemented method of attesting to a sequence of data exchanges between a group, wherein the group comprises a receiving party and one or more sending parties, and wherein the method is performed by a first one of the sending parties and comprises:
sending a respective set of data items to the receiving party, wherein the respective set of data items is a final respective set of a sequence of two or more respective sets of data items;
receiving a respective attestation transaction, wherein the respective attestation transaction comprises a respective output locked to a respective Merkle root of a respective Merkle tree, wherein the respective Merkle tree is based on the respective set of data items and each previous respective set of data items in the sequence;
sending the respective attestation transaction to one or more nodes of the blockchain network, the receiving party, at least one of the one or more sending parties, such that the respective attestation transaction is recorded on the blockchain;
generating a final transaction, wherein the final transaction comprises an input that references the respective output of the respective attestation transaction and comprises the respective Merkle root; and
sending the final transaction to at least one of: one or more nodes of the blockchain network, the receiving party, at least one of the one or more sending parties.

Statement 16. The method of statement 15, comprising:
sending one or more additional respective sets of data items to the receiving party.

Statement 17. The method of statement 15 or statement 16, wherein said generating of the final transaction comprises generating the respective Merkle root of the respective Merkle tree based on the respective set of data items and each previous respective set of data items in the sequence.

Statement 18. The method of statement 17, comprising sending the respective Merkle root to the receiving party.

Statement 19. The method of statement 15 or statement 16, comprising:
for one or more respective sets of data items in the sequence, receiving a respective hash of each data item in the respective set, and wherein said generating of the final transaction comprises generating the respective Merkle root of the respective Merkle tree based on the respective set of data items and the received respective hashes.

Statement 20. The method of statement 15 or any statement dependent thereon, wherein one, some or all of the respective sets of data items comprises a single data item.

Statement 21. The method of statement 15 or any statement dependent thereon, wherein one, some or all of the respective sets of data items comprises multiple data item.

Statement 22. The method of statement 15 or any statement dependent thereon, comprising:
obtaining an initial transaction, wherein the initial transaction comprises an output locked to a public key of the receiving party and a public key of the first sending party, and wherein the respective attestation transaction comprises a respective input that references the output of the initial transaction and comprises a signature corresponding to the public key of the receiving party and a signature corresponding to the public key of the first sending party; and
sending the initial transaction to at least one of: one or more nodes of the blockchain network, the receiving party, at least one of the one or more receiving parties.

Statement 23. A computer-implemented method of verifying a data item was exchanged between a group, wherein the method is performed by a verifier and comprises:
obtaining a final transaction from a blockchain, wherein the final transaction references an output of an attestation transaction and comprises a Merkle root of a Merkle tree, wherein the attestation transaction comprises an output locked to the Merkle, wherein the Merkle tree is based on each set of data items belonging to a sequence of two or more respective sets of data items;
obtaining a set of inner hashes of the Merkle tree; and
performing a Merkle proof for a candidate data item using the set of inner hashes and the Merkle root to verify that the candidate data item belongs to one of the respective sets of data items.

Statement 24. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 23.

Statement 25. A computer program embodied on computer-readable storage and configured so as, when run on one or more processors, to perform the method of any of statements 1 to 23.

According to another aspect disclosed herein, there may be provided a method comprising the actions of the receiving party and at least the first sending party.

According to another aspect disclosed herein, there may be provided a system comprising the computer equipment of the receiving party and at least the first sending party.

1. A computer-implemented method of attesting to a sequence of data exchanges between a group, wherein the group comprises a receiving party and one or more sending parties, and wherein the method is performed by the receiving party and comprises:
receiving a sequence of two or more respective sets of data items, each respective set being sent by a respective sending party; and
for each respective set of data items in the sequence:
generating a respective attestation transaction, wherein the respective attestation transaction comprises a respective output locked to a respective Merkle root of a respective Merkle tree, wherein the respective Merkle tree is based on the respective set of data items and each previous respective set of data items in the sequence; and
sending the respective attestation transaction to at least the respective sending party that sent the respective set.

2. The method of claim 1, wherein one, some or all of the respective sets of data items comprises a single data item.

3. The method of claim 1, wherein one, some or all of the respective sets of data items comprises multiple data items.

4. The method of claim 1, comprising:
for each respective set of data items in the sequence, sending a respective hash of each data item in the respective set to at least the respective one or more sending parties that did not send the respective set.

5. The method of claim 4, wherein said sending of the respective hash of each data item is conditional on the respective one or more sending parties that did not send the respective set signing the respective attestation transaction.

6. The method of claim 1, wherein said sending of the respective attestation transaction comprises sending the respective attestation transaction to at least the respective sending party that sent the respective set prior to receiving the next respective set of data items in the sequence.

7. The method of claim 1, comprising:
for one or more respective sets of data items, generating the respective Merkle root of the respective Merkle tree.

8. The method of claim 1, comprising:
for one or more respective sets of data items, receiving the respective Merkle root of the respective Merkle tree from the respective sending party that sent the respective set; and
for at least one of the one more respective sets of data items, performing a Merkle proof for at least one of the data items in the respective set using the respective Merkle root.

9. (canceled)

10. The method of claim 1, comprising:
generating an initial transaction, wherein the initial transaction comprises an output locked to a public key of the receiving party and one or more additional public keys, each of the additional public keys being associated with a respective sending party, and wherein each respective attestation transaction comprises a respective input that references the output of the initial transaction and comprises a signature corresponding to the public key of the receiving party; and
sending the initial transaction to one or more nodes of a blockchain network and/or at least one of the one or more sending parties.

11. The method of claim 1, wherein the group consists of a single sending party.

12. The method of claim 1, wherein the group comprises multiple sending parties.

13. The method of claim 1, wherein the respective output of each respective attestation transaction is locked to the respective Merkle root of the respective Merkle tree by way of a hash puzzle.

14. The method of claim 1, wherein the respective attestation transaction comprises one or more respective hashes of respective data items upon which the respective Merkle tree is based.

15. A computer-implemented method of attesting to a sequence of data exchanges between a group, wherein the group comprises a receiving party and one or more sending parties, and wherein the method is performed by a first one of the sending parties and comprises:
sending a respective set of data items to the receiving party, wherein the respective set of data items is a final respective set of a sequence of two or more respective sets of data items;
receiving a respective attestation transaction, wherein the respective attestation transaction comprises a respective output locked to a respective Merkle root of a respective Merkle tree, wherein the respective Merkle tree is based on the respective set of data items and each previous respective set of data items in the sequence;
sending the respective attestation transaction to one or more nodes of a blockchain network, the receiving party, at least one of the one or more sending parties, such that the respective attestation transaction is recorded on a blockchain;
generating a final transaction, wherein the final transaction comprises an input that references the respective output of the respective attestation transaction and comprises the respective Merkle root; and
sending the final transaction to at least one of: one or more nodes of the blockchain network, the receiving party, at least one of the one or more sending parties.

16. The method of claim 15, comprising:
sending one or more additional respective sets of data items to the receiving party.

17. The method of claim 15, wherein said generating of the final transaction comprises generating the respective Merkle root of the respective Merkle tree based on the respective set of data items and each previous respective set of data items in the sequence.

18. The method of claim 17, comprising sending the respective Merkle root to the receiving party.

19. The method of claim 15, comprising:
for one or more respective sets of data items in the sequence, receiving a respective hash of each data item in the respective set, and wherein said generating of the final transaction comprises generating the respective Merkle root of the respective Merkle tree based on the respective set of data items and the received respective hashes.

20-24. (canceled)

25. A computer program product embodied on non-transitory computer-readable storage media and configured so as, when run on one or more processors, the one or more processors perform a method of attesting to a sequence of data exchanges between a group, wherein the group comprises a receiving party and one or more sending parties, and wherein the method is performed by the receiving party and comprises:
receiving a sequence of two or more respective sets of data items, each respective set being sent by a respective sending party; and
for each respective set of data items in the sequence:
generating a respective attestation transaction, wherein the respective attestation transaction comprises a respective output locked to a respective Merkle root of a respective Merkle tree, wherein the respective Merkle tree is based on the respective set of data items and each previous respective set of data items in the sequence; and
sending the respective attestation transaction to at least the respective sending party that sent the respective set.

26. A computer program product embodied on non-transitory computer-readable storage media and configured so as, when run on one or more processors, the one or more processors perform a method of attesting to a sequence of data exchanges between a group, wherein the group comprises a receiving party and one or more sending parties, and wherein the method is performed by a first one of the sending parties and comprises:
sending a respective set of data items to the receiving party, wherein the respective set of data items is a final respective set of a sequence of two or more respective sets of data items;
receiving a respective attestation transaction, wherein the respective attestation transaction comprises a respective output locked to a respective Merkle root of a respective Merkle tree, wherein the respective Merkle tree is based on the respective set of data items and each previous respective set of data items in the sequence;
sending the respective attestation transaction to one or more nodes of a blockchain network, the receiving party, at least one of the one or more sending parties, such that the respective attestation transaction is recorded on a blockchain;
generating a final transaction, wherein the final transaction comprises an input that references the respective output of the respective attestation transaction and comprises the respective Merkle root; and
sending the final transaction to at least one of: one or more nodes of the blockchain network, the receiving party, at least one of the one or more sending parties.
